(19) United States
(12) Patent Application Publication
(10) Pub. No.: US 2014/0019157 A1
(43) Pub. Date: Jan. 16, 2014

(54) SYSTEM AND APPARATUS FOR PREVENTING READMISSION AFTER DISCHARGE

(71) Applicant: ClearCare, Inc., San Francisco, CA (US)

(72) Inventors: Geoffrey Howard Nudd, San Francisco, CA (US); Jacquelyn Kung, San Francisco, CA (US); James Merson, San Francisco, CA (US); Anthony Metzler, San Francisco, CA (US)

(73) Assignee: ClearCare, Inc., San Francisco, CA (US)

(21) Appl. No.: 14/023,238

(22) Filed: Sep. 10, 2013

Related U.S. Application Data
(63) Continuation-in-part of application No. 13/940,155, filed on Jul. 11, 2013.
Application No. 13/940,155 is a continuation-in-part of application No. 13/764,581, filed on Feb. 11, 2013.
Application No. 13/764,581 is a continuation-in-part of application No. 13/767,421, filed on Feb. 14, 2013.
Application No. 13/767,421 is a continuation-in-part of application No. 13/625,718, filed on Sep. 24, 2012.
Application No. 13/625,718 is a continuation-in-part of application No. 13/571,305, filed on Aug. 9, 2012.
Application No. 13/571,305 is a continuation-in-part of application No. 13/494,901, filed on Jun. 12, 2012.
Application No. 13/494,901 is a continuation-in-part of application No. 13/444,737, filed on Apr. 11, 2012.
Application No. 13/444,737 is a continuation-in-part of application No. 13/420,506, filed on Mar. 14, 2012.
Application No. 13/420,506 is a continuation-in-part of application No. 13/293,039, filed on Nov. 9, 2011.
Application No. 13/293,039 is a continuation-in-part of application No. 13/277,146, filed on Oct. 19, 2011.
Application No. 13/277,146 is a continuation-in-part of application No. 13/180,447, filed on Jul. 11, 2011.
(60) Provisional application No. 61/857,633, filed on Jul. 23, 2013.
(60) Provisional application No. 61/474,145, filed on Apr. 11, 2011.
(60) Provisional application No. 61/452,443, filed on Mar. 14, 2011.
(60) Provisional application No. 61/394,676, filed on Oct. 19, 2010.

(51) Int. Cl. G06F 19/00

(52) U.S. Cl. CPC G06F 19/3418
USPC 705/2

(57) ABSTRACT

Systems and methods are disclosed for improving healthcare outcomes, such as following discharge of a patient following discharge from a hospital or other facility. In some embodiments, a first computer system of a first entity, detects discharge of a patient from a second entity based on activities of the patient and in response transmits, to an electronic device of a second entity, a request for discharge information of the patient. One or more follow-up activities are automatically scheduled for the patient and participation of the patient in the activities is verified by the first computer system. Follow-up activities may include a visit to a primary care physician (PCP), an in-person phone call, automated phone call, and other activities. One or more escalation actions may be taken based on results of these activities or failure of the patient to take part in these activities.

### RELATED APPLICATIONS

This application claims the benefit of U.S. Provisional Application Ser. No. 61/857,633 filed Jul. 23, 2013, which is hereby incorporated herein in its entirety

This application is a continuation-in-part of U.S. application Ser. No. 13/940,155 filed Jul. 11, 2013, which is hereby incorporated herein in its entirety.

This application is a continuation-in-part of U.S. application Ser. No. 13/764,581 filed Feb. 11, 2013, which is hereby incorporated herein in its entirety.

This application is a continuation-in-part of U.S. application Ser. No. 13/767,421 filed Feb. 14, 2013, which is hereby incorporated herein in its entirety.

This application is a continuation-in-part of U.S. application Ser. No. 13/625,718 filed Sep. 24, 2012, which is hereby incorporated herein in its entirety.

This application is a continuation-in-part of U.S. application Ser. No. 13/571,305 filed Aug. 9, 2012, which is hereby incorporated herein in its entirety.

This application is a continuation-in-part of U.S. application Ser. No. 13/494,901 filed Jun. 12, 2012, which is hereby incorporated herein in its entirety.

This application is a continuation-in-part of U.S. application Ser. No. 13/444,737 filed Apr. 11, 2012, which claims the benefit of U.S. Provisional Application Ser. No. 61/474,145, both of which applications are hereby incorporated herein in their entirety.

This application is a continuation-in-part of U.S. application Ser. No. 13/420,506 filed Mar. 14, 2012, which claims the benefit of U.S. Provisional Application Ser. No. 61/452,443, both of which applications are hereby incorporated herein in their entirety.

This application is a continuation-in-part of U.S. application Ser. No. 13/293,039 filed Nov. 9, 2011, which is hereby incorporated herein in its entirety.

This application is a continuation-in-part of U.S. application Ser. No. 13/277,146 filed Oct. 19, 2011, which claims the benefit of U.S. Provisional Application No. 61/394,676, both of which applications are hereby incorporated herein by reference in their entirety.

This application is a continuation-in-part of U.S. application Ser. No. 13/180,447 filed Jul. 11, 2011, which is hereby incorporated herein in its entirety.

### BACKGROUND OF THE INVENTION

The cost of healthcare continues to rise. Insurers, Governments, and other entities that pay for care have compelling interests to control the cost of healthcare while still providing quality outcomes for patients. One particularly costly issue is the readmission of patients shortly after discharge from a hospital. Studies have shown that such activities as a visit with a primary care provider, a follow up phone call from a health care professional, or even an automated phone call (e.g. IVR) with questions about a patient's condition.

The systems and method disclosed herein provide an improved approach for ensuring that a patient engages in follow-up activities following discharge from a hospital or following medical treatment such as surgeries.

### BRIEF DESCRIPTION OF THE FIGURES

FIG. 1 is a schematic block diagram of a computing device;

FIG. 2 is a schematic block diagram of a system for implementing methods in accordance with an embodiment of the present invention;

FIG. 3 is a schematic block diagram of entities that may participate in performing methods in accordance with an embodiment of the present invention;

FIG. 4 is a process flow diagram of a method for facilitating post-discharge activities in accordance with an embodiment of the present invention;

FIG. 5 is a process flow diagram of a method for performing an automated interactive call in accordance with an embodiment of the present invention;

FIG. 6 is a process flow diagram of another method for performing an automated interactive call in accordance with an embodiment of the present invention;

FIG. 7 is a process flow diagram of a method for obtaining discharge information in accordance with an embodiment of the present invention;

FIG. 8 is a process flow diagram of a method for incorporating a pharmacy into provisioning of follow-up care in accordance with an embodiment of the present invention;

FIG. 9 is a process flow diagram of a method for detecting discharge using a scheduling system in accordance with an embodiment of the present invention;

FIG. 10 is a process flow diagram of a method for relating a detected discharge to a previous discharge in accordance with an embodiment of the present invention;

FIG. 11 is a process flow diagram of a method for obtaining discharge information from a care provider in accordance with an embodiment of the present invention; and

FIG. 12 is a process flow diagram of method for verifying a report of a discharge in accordance with an embodiment of the present invention.

### DETAILED DESCRIPTION OF THE INVENTION

In the following description of embodiments of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

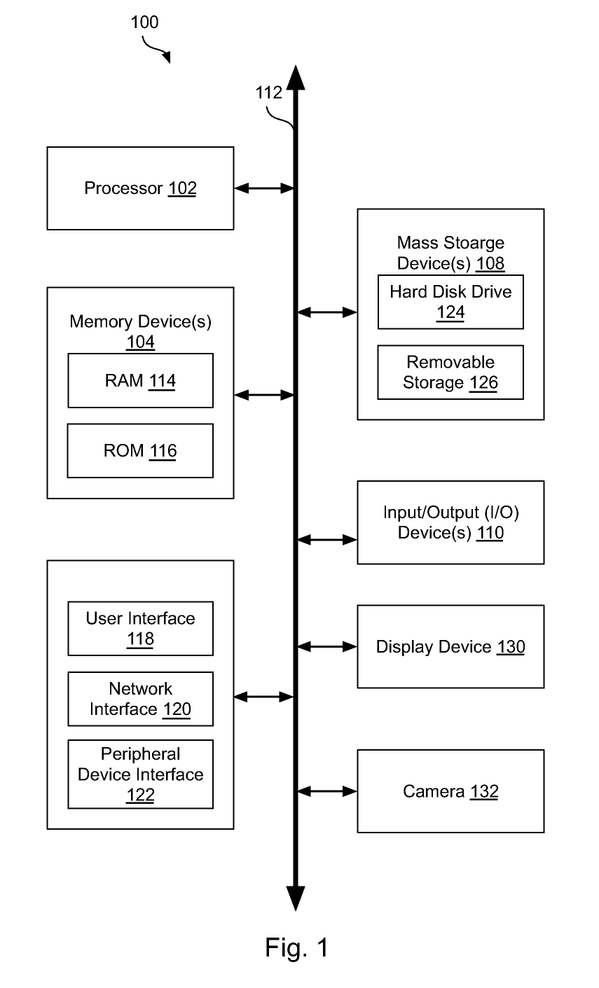

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like. The computing device 130 may additionally include a digital camera 132, scanner, or other image input device operably coupled thereto.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

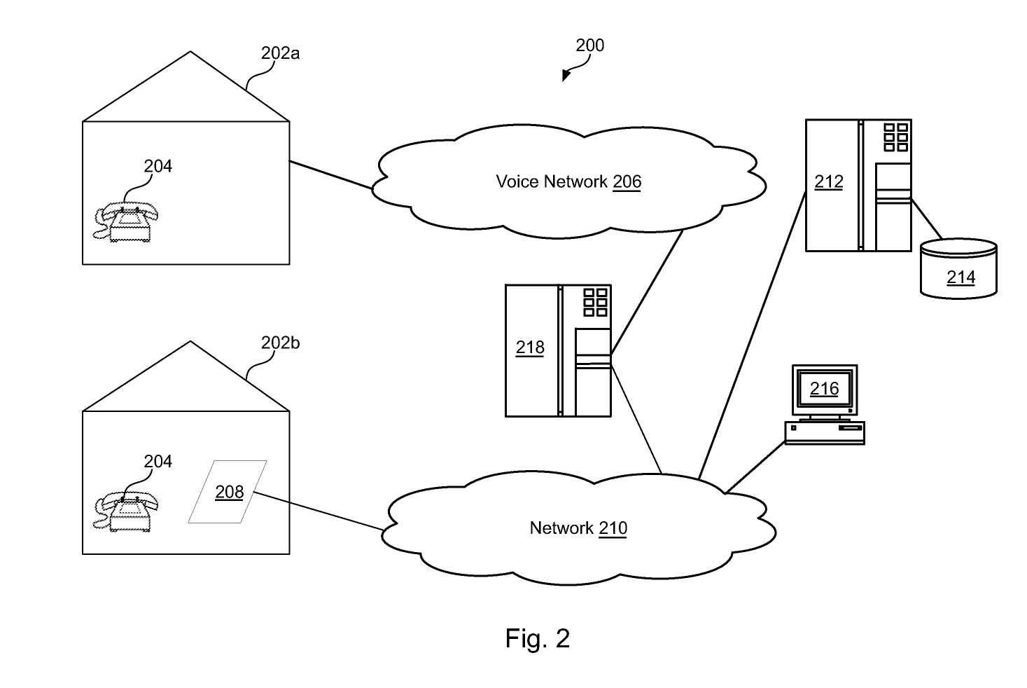

FIG. 2 is a block diagram of an example network environment suitable for use in accordance with one or more embodiments of the present invention. Employees in various premises 202a-202b may perform work, which may be client owned or recipient owned premises 202a-202b. The premises 202a-202b may have one or more telephones 204 installed therein that are connected to a voice network 206. The voice network may be a POTS telephone network, cellular network, voice-over-IP (VOIP), network or any other network suitable for transmitting and receiving analog or digital voice information.

The premises 202a-202b may have one or more computing devices 208 provided by a provider of work, e.g. health care agency, or a client or recipient of work. The computing device 208 may be a tablet computer, smart phone, computer terminal, or other computing device. The computing device 208 may have some or all of the attributes of the computing device 100. The computing device 208 may connect to a network 210 by means of a wired or wireless connection. The network 210 may include the Internet and one or more intermediate local area networks (LAN).

A work management server 212 may also connect to the network 210 directly or by means of one or more intervening LANs. The work management server 212 may have some or all of the attributes of the computing device 100. The work management server 212 may facilitate the assignment and monitoring of work taking place at a plurality of premises 202a-202b remote from the work management server 212. The work management server 212 may host or be operably connected by an intervening network to a database 214 containing information regarding work scheduled to take place at the remote premises 202a-202b. The work management server may receive information regarding activities taking place on the remote premises from a computing device 208 or telephone 204 located at the remote premises 202a-202b. In particular, the work management server 212 may implement some or all of the methods disclosed in the applications incorporated herein by reference in the “Related Applications” section.

Telephones 204 may communicate with the work management server 212 by means of a voice server 218 operable to route telephone network traffic over a digital network. The voice server 218 may be operable to convert voice information input to the telephone 204 to text and/or convert voice messages to digital files that may be routed over the network 210. Likewise, the server 218 may be operable to convert text received into voice messages routed over the voice network 206. The server 218 may be provided by a commercial venture such as Twilio which provides application programming interfaces (APIs) which are readily usable by those skilled in the art of software programming to build computer-enabled applications which use telephony, including voice recognition, voice-to-text automated transcription, text-to-voice technologies, and text messaging, to serve a variety of purposes.

One or more of workers, managers, clients, and recipients of work, and other concerned parties may access information regarding activities taking place at the premises 202a, 202b by means of a workstation 216 in data communication with the network 210. The workstation 216 may be embodied as a computer, smart phone, tablet computer, or the like. The workstation 216 may have some or all of the attributes of the computing device 100.

The illustrated environment of FIG. 2 may be used to perform some or all of the methods for managing remote healthcare workers described in the applications incorporated herein by reference in the “Related Applications” section.

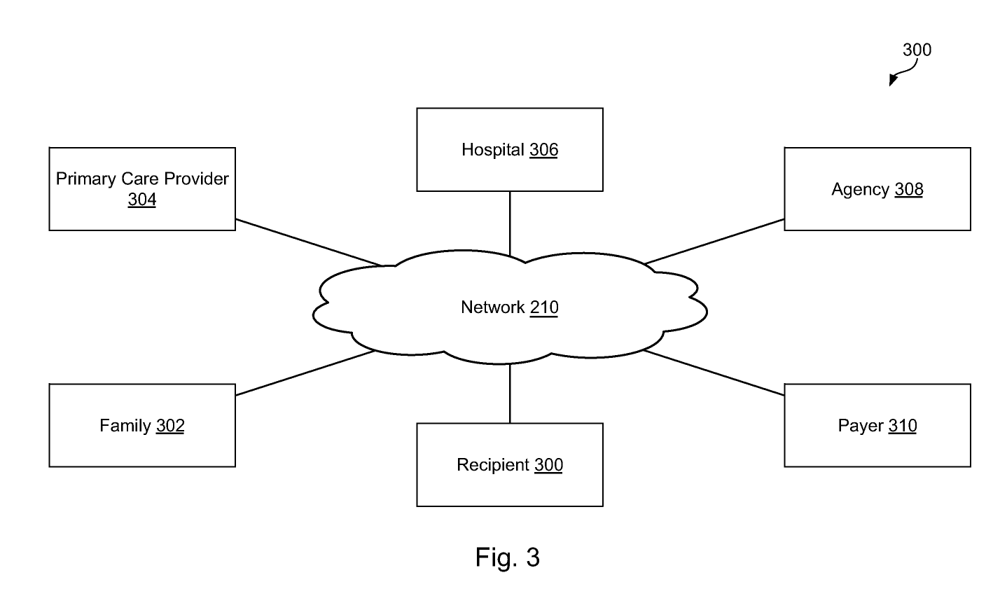

Referring to FIG. 3, various constituencies may take part in methods disclosed herein. Example constituencies may include a recipient 300 (e.g. patient), family members 302 of a recipient, a primary care provider 304, a hospital 306, agency 308 (i.e. health care agency providing in-home care, nursing home, or other health care services to a recipient 300), and a payer 310 (i.e., party contracting for health care services for the recipient such as a family member, insurance company, government, or the like).

For purposes of this disclosure, each constituency may include some or all of the computing device noted above in FIG. 2 having some or all of the attributes of the computing device of FIG. 1. Communication with or between constituencies may be viewed as electronic communication between computing devices associated with the constituency using one of a plurality of communication modalities.

Communication modalities may include voice communication, automated voice communication (e.g. text-to-voice), text message, email, system-to-system communication, an electronically generated prompt displayed to a human agent to perform the communication, communication with or by a web portal, or any other electronic means of communication.

In accordance with some or all of the methods disclosed herein, aspects of a recipient's condition or environment may be sensed using one or more sensors. Sensors may include such devices as a biosensor, hydrometer, accelerometer, pressure sensor, capacitive sensor, microphone, radio frequency (RF) detector, proximity sensor, imaging sensor, thermal imaging or sensing system, personal emergency response system (PERS), a wearable or implantable sensor. Sensors may sense such things as blood pressure, weight, glucose level, heart rate, location, breathing rate, time of day, blood oxygen level, movement, cholesterol, heart rate, falling, and the like. Examples of such sensor include Health Buddy™ from BOSCH™, CarioCom™, various biosensors available form General Electric™, and others.

Table 1 lists examples of sensors, communication modalities and constituents that may participate in performance of the methods disclosed herein. Any sensor may communicate by any communication modality in order to provide information to any constituent. For example for a given set of constituencies Cᵢ, a set of communication modalities Mⱼ, and a set of sensors Sₖ, any combination of the same, e.g. a path Sₖ->Mⱼ->Cᵢ, may be implemented and used to perform methods disclosed herein.

TABLE 1
Sensors, Communication Modalities, and Constituents.

| Sensor Type | Sensor Description |
|---|---|
| GPS | Sensor that determines absolute location via GPS satellites. |
| WLAN | Sensor dedicated to facilitating a device connection to a wireless network. |
| | Identification and location can be established with this sensor. |
| Gyroscope | Device that measures orientation |
| Accelerometer | Sensor that measures proper acceleration and velocity. |
| Force | Sensor that measures dynamic impact. |
| Magnetometer | Instrument used to measure the strength and direction of magnetic fields. |
| Atmospheric | Sensor that measures fluctuations in pressure with the environment's |
| Pressure | atmosphere. |
| Hygrometer | Instrument used for measuring the moisture content in the environment. |
| Temperature | Device that measures temperature or temperature gradient. |
| Capacitive Touch | Sensor that takes human body capacitance as input. This instrument can |
| | detect and measure proximity, position or displacement, humidity, fluid |
| | level, and acceleration |
| Microphone | Sensor that converts sound into an electrical signal. |
| Photo-detector | Instrument that senses and measures light or other electromagnetic |
| | energy. |
| Proximity | Sensor able to detect the presence of nearby objects without any physical |
| | contact. |
| RF Module | Device used to transmit and/or receive radio signals of various |
| | frequencies. |
| Image | Device that converts an optical image into an electronic signal. |
| Fingerprint | Instrument that views and/or captures an individual's fingerprint. |
| Motion | Sensor that can sense and capture motion within an environment. |
| Personal | Instrument that when activated creates an alert to an emergency situation. |
| Emergency | |
| (PERS) | |
| Time Clock | Instrument utilized to measure the passing of time. |
| Blood Pressure | Sensor utilized to measure blood pressure. |
| Glucose | Instrument that measures and/or records the glucose levels of a blood |
| | sample. |
| Pulse Oximeter | Device that indirectly monitors the oxygen saturation of a person's blood. |
| Scale | Instrument that measures and/or records mass or weight. |
| Posture | Device that monitors and/or records a person's posture |
| Respiration | Sensor utilized to measure respiration rate and status. |
| Inhaler | Monitors when and where a person utilizes an inhaler medication. |
| Heart Rate | Instrument utilized to measure and/or records a heartbeat. |
| Electrocardiogram | A device that measures the electrical impulses of the heart [ECG, EKG]. |
| Doppler | Instrument that measures blood flow and blood pressure. |
| Ultrasound | |
| Sleep | Device that monitors and/or records a person's sleep movement, |
| | biometrics, and brain activity. |
| Pedometer | Sensor that measures velocity and distance. |
| Activity | A device that measures the dynamic change of an inanimate or animate |
| | object. |
| Medication | An instrument that monitors the occupancy of medication containers, |
| | their and their refill schedule. |
| Web Browser | A software application utilized by the end-user to send/receive |
| | information resources between the end-user's computing device and web |
| | server. |
| Telephonic Device | An instrument utilized in telecommunications for processing |
| | incoming/outgoing sound transmissions. |
| Modem | An instrument utilized to connect a computing device to an ISP or mobile |
| | network provider. |
| Mobile | A portable personal computing device such as a: tablet, laptop, or PDA. |
| Computing Device | |
| Mobile Phone | A wireless phone with telephonic and data communication functions. |
| Device | |
| Personal | A computing device utilized by an end-user. |
| Computing Device | |
| Computer Server | A centralized or decentralized computing device that stores, recalls and |
| | manages software system assets. |

| Communication Modality | |
|---|---|
| Name | Modality Description |
| Email | Electronic message sent via Internet or network. |
| SMS | Text messaging service protocol to/from mobile phone |
| | devices. |
| IVR | A telephony technology in which someone uses a touch-tone |
| | telephone to interact with a database to acquire information |
| | from or enter data into the database. |
| Telephony | A telecommunications system in which telephonic equipment |
| | is utilized in the transmission of speech or sound between |
| | points, with or without the use of wires |
| Web Portal | A website utilized for storing, recalling, and managing data or |
| | computing assets. |
| Instant Message | An instant electronic transmission sent via private network. |
| Verbal Communication | Messages that are relayed by an individual through speech or |
| | sound. |
| Electronic Documentation | Message content is relayed and tracked through an electronic |
| | device and/or system. |
| Video Conferencing | A camera system is utilized to transmit/receive live video and |
| | audio transmissions. |
| Paper Documentation | Information is recorded as text or imagery on a paper |
| | document. |

| Constituent Name | Constituent Description |
|---|---|
| Agency | Organization that manages and provides home and/or health |
| | care. |
| Client | Individual that receives home and/or health care. |
| Caregiver | Employee or contractor that provides caregiving services on |
| | behalf of the Agency to the Client. |
| Family | Blood and/or legal relatives of the Client. |
| Provider | Medical specialist responsible for maintaining the Client's health. |
| Payer | Individual or organization responsible for settling home and/or |
| | health care related expenses for the Client. |
| Pharmacy | Organization that fulfills and manages a Client's medication |
| | requirements. |
| Pharmacy Benefits | Third-party administrator responsible for processing and paying |
| Manager | prescription drug claims. |

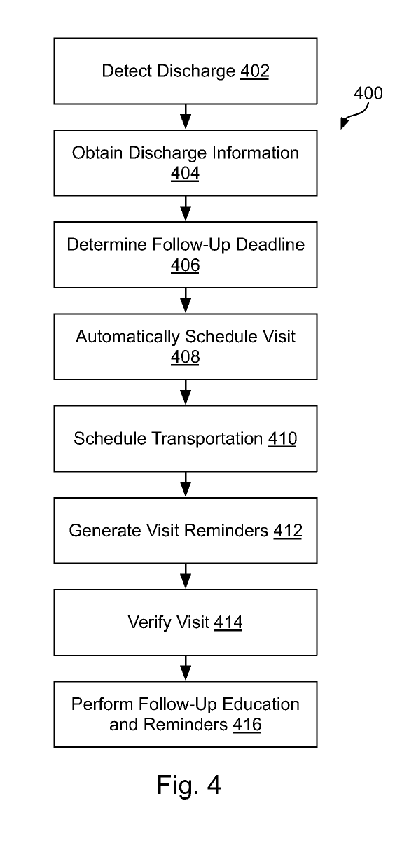

Referring to FIG. 4, a method 400 may be performed in order to reduce the likelihood of readmission of a patient following discharge or otherwise improve healthcare outcomes. The method 400 may be executed by a computer system, such as by a computer system 100 executed by any of the constituents of FIG. 2, such as a health care agency that provides long-term and/or in-home care to a plurality of patients. The method 400 may advantageously reduce the risk of readmission shortly after discharge from a hospital, such as following congestive heart failure (CHF) or other condition. The likelihood that a patient will be readmitted increases significantly if the patient does not visit a primary care physician (PCP) within five days of discharge.

The method 400 may include detecting 402 discharge of a patient. Detecting 402 discharge of a patient may invoke the methods described herein for facilitating a visit with a primary care physician or other actions for reducing the likelihood of readmission of a patient. In particular, discharge may be detected by an entity, such as an agency, without express notification of such from another entity, such as a hospital, out-patient surgical center, sub-acute rehabilitation facility, physical therapy facility, or some other facility. For example, admission and/or discharge may be detected based on activities of the patient and may be detected exclusive of any communication from the hospital.

Admission and discharge of a patient may be detected 402 automatically by means of a geotracking system, such as a GPS device in a recipient's mobile phone. For example, if a recipient is sensed to be at a location corresponding to a hospital for an above-threshold amount of time (e.g. 24 hours), then upon detecting the recipient leaving the location of the hospital discharge may be deemed to have been detected. A patient may also be detected to have been admitted and discharged due to autologging of the patient's position using a radio frequency identification (RFID) system located at the hospital detecting an RFID tag worn by the patient, such as a bracelet provided by the hospital or the owner or controller of the executing system (“the executing entity”). A provider list may be maintained or accessed that relates a hospital to a location or boundary. A detected location of the patient or logging of the patient location by any of the above means may be compared to the provider list to determine if the patient has been at a hospital for the threshold amount of time and been discharged therefrom. The provider list may be obtained from an official source or gathered from publicly available information.

In some embodiments, admission of the patient may be detected by means of analysis of scheduling data for the patient according to the scheduling systems described in the applications incorporated by reference in the “Related Applications” section. For example, if a scheduling system records that a patient does not need care for a period due to admission in a hospital, this information may be analyzed and used to determine that the patient was admitted and subsequent scheduling of the patient may be used to detect 402 that the patient was discharged.

Discharge may also be detected 402 by system-to-system communication from a hospital computer system to a computer executing methods as described herein, hereinafter the executing system. Discharge may also be detected by entry of the fact of a discharge for a patient into a web portal associated with the executing system. The fact of a discharge may also be reported by a payer that receives this information as part of an invoice or other notification from the hospital.

In some embodiments, discharge may be detected by obtaining information from one or more of the constituencies noted above by means of any communication modality. For example, one or more constituencies may be polled at some frequency, e.g. every N days. The value of N may be chosen based on the time period after discharge in which follow up care should occur. For example, where M is the number of days after discharge that follow up care should occur, N may be chosen to be less than or equal to M.

In some embodiments, a task for a caregiver or other interactive routine for updating the status of a task according to any of the methods disclosed in the applications incorporated herein in the “Related Applications” may include a task for a caregiver to specify by any communication modality whether a patient has been admitted to the hospital and/or discharged from the hospital or engaged in other activity requiring follow up care. For example, a voice telephony dialog may include a prompt to enter whether a patient has been admitted and/or discharged and/or a date of admission/discharge.

In some embodiments, a care manager or other agency representative may be prompted periodically and/or while entering a care schedule for a patient, modifying a care schedule for the patient, canceling one or more shifts to be worked on behalf of a patient, deactivating or terminating a patient in a care system, reviewing care logs, or otherwise accessing or entering data for the patient according to the methods disclosed in the applications incorporated by reference in the “Related Applications” section. The prompt may ask the agency representative to indicate whether the patient has been admitted and/or discharge and whether the date of admission and/or discharge. This information may then be received by the executing system and used to detect 402 discharge of the patient

Likewise, an interface for reporting patient information to family members may be configured to display or otherwise output a prompt to indicate whether the patient has been admitted to the hospital and/or discharged from the hospital or engaged in other activity requiring follow up care.

The prompt or interface for a caregiver, family member, or other constituency, to indicate whether a patient has been admitted may further include functionality or interface elements to prompt the constituency to specify a date of admission and/or discharge in the event that the constituency indicates that admission and/or discharge has occurred.

If information received by the executing system in response to the prompts to indicates that admission and/or discharge has occurred, the executing system may accordingly determine that discharge of the patient has occurred or will occur at some point after admission.

As for other methods disclosed herein, prompts and queries regarding discharge may be replaced with or augmented with queries regarding other activities (e.g. surgeries) that do not require admission but nonetheless require follow up care.

The method 400 may further include obtaining 404 discharge orders from the hospital. Obtaining 404 discharge orders may be obtained by system-to-system communication. Obtaining 404 discharge orders may also include sending an automatically generated fax or mailing to a hospital or other facility from which the patient was discharged. The automatically generated communication may reference a physical address, electronic address (e.g. email), or fax number to which the discharge orders should be sent. The response to the communication may be received automatically. For example, am email may be automatically ingested and discharge information extracted. Likewise, a fax including the discharge orders may be received by a computer system operable to extract information therefrom (e.g. optical character recognition).

The method 400 may further include determining 406 a deadline for a recipient to visit a PCP subsequent to a discharge may be determined by various means. For example, the deadline may be part of discharge orders provided to a patient and reported to the executing system by any of the communication modalities described herein. The deadline may also be reported to the executing system by any of the above constituents to whom such information was reported by any of the communication modalities. For example, the information may be input to a web portal provided by the executing system, such as by hospital staff, a payer, a family member, or other constituency.

In some embodiments, where no explicit deadline is given, the deadline may be inferred from one or more sources such as guidelines provided by an insurance provider, a medical authority (i.e. research or reference). In some embodiments, the deadline may be determined from any of these sources based on information known about the patient, e.g. a patient's medical history and/or the discharge orders. For example, the condition for which the patient was treated and factors that affect the risk for that patient either in general or specific to the condition for which the patient was treated may be evaluated with respect to rules for evaluating such information in the reference information to determine the deadline for the patient to visit a PCP.

A deadline for visiting a PCP as determined as described herein may be used to automate and/or facilitate scheduling 408 of an appointment with a PCP. For example, an alert may be generated some point prior to the deadline, e.g. N days, and transmitted to any of the constituencies described above by any of the communication modalities. For example, an automated phone call, text message, email, or other message may be transmitted to a patient with a reminder to schedule an appointment prior to the deadline. An automated phone call, text message, email, or other message may be transmitted to a PCP associated with a patient with a reminder to schedule an appointment prior to the deadline. The PCP may then follow up with the patient to schedule an appointment.

An alert by any communication modality may include a link, voice prompt, code, or other information enabling the recipient to schedule the appointment by interfacing with a scheduling system of a PCP or other entity. For example, a link to a web portal for scheduling an appointment. The link may additionally or alternatively invoke filling of fields with a date, time, patient information, or other data for scheduling the patient appointment.

Scheduling 408 may further performed by an application executing on a mobile phone or other device. This application may be invoke in response to a user selecting or otherwise interacting with a notification to schedule an appointment generated in response to detecting discharge and determining a deadline as described above. In some embodiments, a user may schedule an appointment in accordance with methods described herein. The executing system may detect scheduling of the appointment, either by reporting of the scheduling by a constituency or by the scheduling being performed by way of the executing system.

For example, the method 400 may include using the date and time of the scheduled appointment to invoke scheduling 410 of transportation from the patient's residence to the location of the PCP. For example, a message requesting the transportation may be transmitted to a car service, taxi service, a family member who has undertaken to provide transportation, or some other entity. The message may be transmitted by any of the communication modalities. Confirmation of the scheduling of the transportation may be sent to the recipient, PCP, family member, or some other constituency.

In some embodiments, a patient's need for transportation may be transmitted to a crowdsourcing forum that facilitates coordination of transportation for multiple patients and multiple transportation providers. For example, a request for transportation at a date and time or a range of dates and/or times may be posted for a forum. The forum may identify clusters of closely located patients and/or a cluster of closely located PCPs. A transportation provider may participate in the forum, accept requests for transportation, and fulfill them. The crowdsourcing forum may facilitate communication between transportation providers and patients. For example, notification of acceptance of a request may be transmitted by means of the crowdsourcing forum to the patient that submitted the request. The notification may provide a time/date of pickup and pickup for a return trip.

In some embodiments, the executing system may schedule 410 transportation by clustering patients transportation needs together based on one or more criteria, such as geographic proximity of residences, proximity of deadlines for PCP visits, proximity of discharge dates, geographic proximity of PCP, and the like. The executing system may generate a route for a transportation provider to pick up, drop off, pick up for a return trip, and drop off at a residence, a plurality of patient's with PCP visits. The executing system may propose visit dates and times in accordance with this routing plan and initiate scheduling of such a visit, such as according to methods described hereinabove.

In some embodiments, the executing system may send an alert to one or more second patients in proximity to a first patient (i.e. same neighborhood, same facility) when a first patient has scheduled transportation to a PCP. The second patients may be identified as those having a recent discharge but have not yet participated in a visit, have scheduled a visit around the time the first patient is scheduled to depart, or some other criteria.

In some embodiments, the executing system may cluster patients detected to be in need of a visit (e.g. between discharge and a deadline for making a visit but have not yet had a visit) and schedule visits and/or transportation for the cluster with the PCP and/or transportation provider in order to reduce transportation costs.

The method 400 may include generating 412 reminders and transmitting them to a patient or other constituency by any of the communication modalities in advance of an appointment. In some embodiments, reminders may also be sent to the PCP in order to alert the PCP that the patient will be coming.

The method 400 may include verifying 414 that a visit took place. For example, notification of a visit taking place may be transmitted to the executing system, such as by a system-to-system communication from the PCP, payer, or some other constituency. Verification of a visit may also be accomplished by detecting logging of an RFID tag worn by the recipient and the PCP's location, detecting, using a GPS receiver, that the patient was at the PCP's location on or around the time of the appointment, or by some other means. Verification may also be accomplished by manual entry through a web portal or some other interface to the executing system by means of any constituency.

If a visit has been verified, the executing system may send notice of this fact to a constituency, such as the discharging hospital, family member, payer, or the like. Likewise, if a visit has not been verified by the executing system after the scheduled time for the visit, notice of this fact may also be sent in the same manner. Likewise, if a visit is determined by the scheduling system not scheduled at all before the deadline, notification may also be sent in the same manner.

In some embodiments, in addition or in place of scheduling 408 and/or verifying 414 a PCP visit as described herein, other actions may be taken in response to detecting discharge. For example, the executing system may invoke a teleconference, or scheduling of a teleconference, with a medical professional, such as using an existing interface for scheduling such visits. The executing system may transmit information to the teleconferencing medical professional, such as discharge documents for the patient, some or all of the patient's medical history, or other information. In some embodiments, the executing system may request the teleconference. The teleconferencing medical professional may then follow up with the patient to conduct the conference. In other embodiments, the executing system may facilitate scheduling the appointment and confirming scheduling with the patient. Verification of the teleconference taking place may be detected by the executing system such as the teleconference taking place by way of the executing system or notification transmitted from the teleconferencing medical professional and received by the executing system.

In some embodiments, in addition or as an alternative to any of the above actions, a registered nurse or employee associated with the executing system may be prompted to review the patient's discharge documents and/or medical history within N days of discharge and take appropriate action. Appropriate actions may include an in-home visit or facilitating scheduling of a visit with the PCP.

In some embodiments, in addition or as an alternative to any of the above actions, a visit of the patient with or to a “minute clinic” may be facilitated. For example, a patient may have a RFID tag or GPS receiver that logs the patient's location. The executing system may relate the patient's location to locations of mobile or stationary clinics and send alerts to one or both of the clinic and the patient when they are nearby. For example, the patient is shopping within a block of a clinic. The executing system detects this and sends an alert by, for example, text message, or some other communication modality, to the patient to stop by the clinic for a post-discharge checkup. Alternatively or additionally, the executing system detects that a mobile clinic is within a predetermined proximity to the patient, and transmits a message to the mobile clinic with an instruction or suggestion to visit the patient's home or other current location. In a like manner, a doctor that performs house calls may be alerted or requested to visit the patient's home or current location in response to detecting discharge of a patient and a deadline for making a PCP visit.

In some embodiments, in addition or as an alternative to any of the above actions, a checklist of post discharge actions each having a status associated therewith that may be updated may be presented to a patient, family member, or other constituent. For example, a web portal or dedicated application may receive checklist from the executing system and present an interface for viewing and updating the checklist on a device. For example, the web portal may be implemented as described in

The method 400 may further include performing 416 some or all of follow-up education and reminders to help the patient perform activities to facilitate healing and/or maintain health. For example, in some instances, a PCP visit following discharge is important in order to clarify medications the patient is required to take. Accordingly, in response to detecting discharge, methods described herein may be invoked on behalf of a patient, family member, or other constituent in order to facilitate filling of prescriptions and proper taking of medications.

For example, the executing system may receive discharge instructions that include medications and/or have access to other medications prescribed for the patient. The executing system may transmit for display to the patient content and/or interfaces for facilitating taking of medication. For example, a interface displaying a visual representation of pills and a dosage amount (e.g. a picture of two pink pills). Alternatively, textual description of the pill and the quantity may be provided in the interface. Likewise, for liquid medications amounts and measuring instructions may be provided. For inhalable and injectable medications instructions, descriptive information, and the like ma be provided in the interface. Instructions may include diagrams of where to inject, instructional videos, slideshows, audio files with spoken instructions, or other content. Such content may be obtained from a library of such content assembled for medications and procedures. The information may be obtained from vendors, researches, or other authorities.

In some embodiments, such content may be reviewed with the patient at a hospital by means of an application that retrieves and presents such information in the same manner as described above. In some embodiments, this content may be recorded on a DVD or other media for sending with a patient upon discharge. In some embodiments, this content may be accessed over an Internet enabled television. Information may also be provided via automated telephone calls that present such information in audio format and then prompt to provide confirmation that a medication was taken (“press 1 if medication was taken”, “press 2 if medication was filled”).

The prescription information may also be used to generate alerts for when to take medications according to dosage information. The alerts may include some or all of the content described above. The alerts may be transmitted using any communication modality and may be transmitted to a patient, family member, caregiver, or other constituent. Often people will stop taking medications too soon or for too long. Alerts may also be transmitted alerting a patient to stop taking medication. In some embodiments, reminders may include an interface element by which a patient may confirm that the alert was received and the medication taken. When such confirmations are not received within a threshold time after a dosage is due, additional alerts may be generated to the patient and escalation may be performed wherein alerts are sent to additional constituent such as PCP, in home care provider, or other additional constituent. In some embodiments, whether a patient has or has not taken medication may be determined using one or more sensors, such as an electronic pill box that detects opening and closing, removal of pills, or the like. This information or lack thereof may be used to generate alerts as described.

In some embodiments, the executing system may take action to ensure that prescriptions are filled. For example, a patient or other constituent may take a picture or otherwise scan a bar code or other identifying information on a prescription fill and transmit this information to the executing system, which then records filling of the prescription. If such a confirmation is not received at an expected time at which a previous filling of the prescription would be exhausted according to a dosage schedule, or some threshold time previous to such a time, an alert may be transmitted to the patient or some other constituent by a communication modality.

In some embodiments, whether a prescription has been filled may be obtained for generating alerts as described above from a medical information system such as Relay™. Alerts may be generated according to information as described above.

In some embodiments, any and all of the methods described above for scheduling PCP visits following a detected discharge may also be used to schedule other services in accordance with discharge data, such has a physical therapist, occupational therapist, or the like.

As an example method the executing system may detect discharge of the patient, obtain authorization to access the patient's medications, retrieve the patient's medication information from an appropriate database (e.g. Relay, IMS, other database), create tasks for dosage times, create tasks for refill times, create tasks for prescription ending. Reminders for and updates to the status of these tasks may then be generated and transmitted to the patient and/or other constituent.

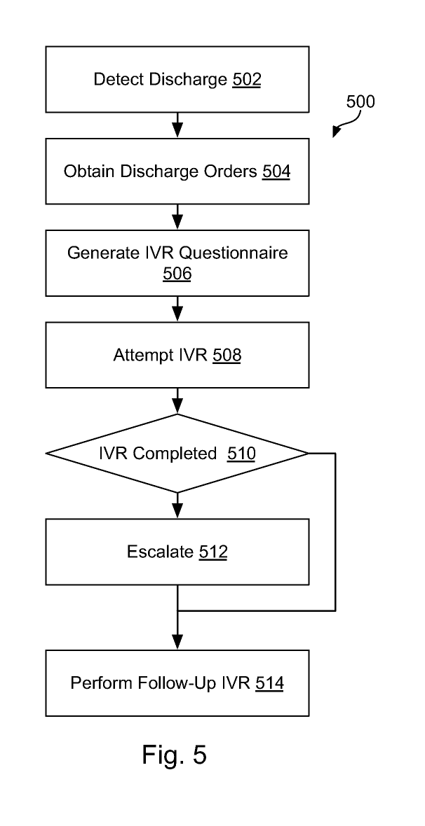

Referring to FIG. 5, a method 500 may be used to perform an automated interactive voice response (IVR) phone call with a patient. The method 500 may be executed by an executing system in the same manner as for the method 400 or may be invoked by the executing system. For example, an entity having the equipment for performing IVR calls may perform the IVR call in response to a request from the executing system specifying the content of the IVR call. The entity may then return responses to the executing system.

The method 500 may include detecting 502 discharge and obtaining 504 discharge orders as for other methods disclosed herein. The method 500 may further include generating 506 an IVR questionnaire. For purposes of this disclosure, a questionnaire may be an interactive questionnaire, such that questions chosen for reading to a patient may be selected based on responses to previous questions. A questionnaire may include questions as well as instructions, e.g. instructions to seek care if a patient's response indicates that the patient's condition warrants it or that the patient is not following proscribed behaviors (e.g. activity, medications, etc.). Generating 506 the IVR questionnaire may include evaluating some or all of the treatments performed as indicated in the discharge orders, proscribed activities and medications specified in the discharge orders, and a patient's medical history as known to the executing system independent of the discharge orders. Some or all of these sources of information may be evaluated, such as with respect to reference materials, to determine appropriate questions to ask for the patient. For example, a person having undergone a given treatment and having a certain medical history may be likely to have certain complications as indicated in medical literature. Accordingly, the IVR questionnaire may ask question regarding whether the patient has experienced any of the complications, has been engaging in activities promoting recovery for that treatment, has been taking medications as prescribed in the discharge orders, or other questions. Where a treatment plan or other behavioral intervention is proscribed for the patient, the questionnaire may be generated 506 by generating questions verifying that these activities are taking place.

The method 508 may further include attempting 508 to perform an IVR phone call with the patient. As noted above, the actual IVR call may be handled by another entity. Accordingly, attempting 508 to perform an IVR phone call may include submitting the questionnaire and contact information to another entity with an instruction to perform an IVR call.

The method may include evaluating 510 whether the IVR call is found 510 to have been completed. For example, where another entity performs the IVR call, a result of the call, e.g. patient responses may be returned thereby indicating a successful call. Alternatively, the entity may report that the call (or a number of attempts to make the call) failed to achieve a successful call by a predetermined deadline.

If the call is found 510 not to have been completed, e.g. completed within a threshold time interval after discharge, then the method 500 may include escalating 512. Escalating 512 may include outputting a prompt by the executing system to a representative to make an in-person phone call to the patient, an in-person visit to the patient. Escalating 512 may also include an emailed or mailed reminder, or the like. Escalation may include a series actions, such as any of the escalation actions mentioned herein, each action following a previous action that fails to establish desired contact with the patient.

In some embodiments, escalation may include notifying a PCP or other concerned party of the failure of the patient to participate in an IVR call, schedule a visit, attend a visit, or take some other post-discharge action. In such embodiments, steps may be taken to verify that the recipient of such a notification is in fact the PCP or authorized representative of the PCP for confidentiality purposes.

In either case, in response to an attempted 508 IVR and or escalation actions 512, a follow-up IVR may be performed 514. In some embodiments, questions for the follow-up IVR may be generated based on the same materials as the original questionnaire generated at step 506. The follow-up IVR may be further based on responses to the original VIR and/or other intervening activities or changes to the patient's condition known to the executing system. For example, if a patient is asked to rate his/her pain and the pain level from one IVR session to the next shows worsening, appropriate questions may be asked on this basis and one or more escalations may additionally or alternatively be performed.

In some embodiments, escalation may include generating a notification by any communication modality to a PCP or other entity. Notification may be proceeded or include obtaining an “opt-in” from the PCP and or verifying that an addressee for the notification is the PCP or authorized representative. For example, a PCP may opt in to a system provided by the executing system and accordingly provide an address or phone number to which communication can be properly transmitted. As part of the opt in process, the PCP may establish a voice signature, digital signature, password, or other authenticating information that may be used to authenticate a recipient of a notification before providing confidential information. Alternatively some other unique identifier or authenticating information may be requested and received from a PCP A PCP may be prompted to opt in by transmitting a fax that the PCP may then sign or otherwise fill and then return to the executing system in order to authorize provision of notifications to the PCP. In some embodiments, a physician may be prompted to enter a voice signature as part of an initial phone call according to the methods disclosed herein or as part of an opt-in process. In some embodiments, authorization of an addressee of a notification may be presumed by using an official phone number, email address, or other contact information for the addressee from an official source, such as a registry for doctors.

In some embodiments, notifications as part of an escalation may be in the form of an email transmitted to the PCP or other entity. The link, when clicked may direct the recipient's computer system to a web page including the notification, e.g. a notification that the patient should have taken action and has not done so.

In some embodiments, escalation in response to any of the above-mentioned failures of the patient to engage in follow-up activities may include generating an automated notification to an emergency room, 24/7 medical care provider, a wing of a hospital the treats the patient's condition (as determined from discharge orders or the patient's medical profile), or some other entity. In some embodiments, these entities may be called in response to failure to verify contact with a PCP or other entity.

The method 500 may be preceded by enrolling the patient to receive an IVR call. For example, pre- or post-discharge, the executing system may make an automated call, send an email, or the like prompting the patient to enroll, over the phone, online, or by some other interface. A patient may also be enrolled by a person who performs a face-to-face visit or phone call with the patient in order to obtain enrollment information and consent to enrollment from the patient. A patient may also enroll by returning a signed document to that effect. Discharge orders may indicate to the patient that enrollment and/or a follow-up IVR call or other follow-up action will take place. Discharge orders may include instructions to the patient on how to enroll.

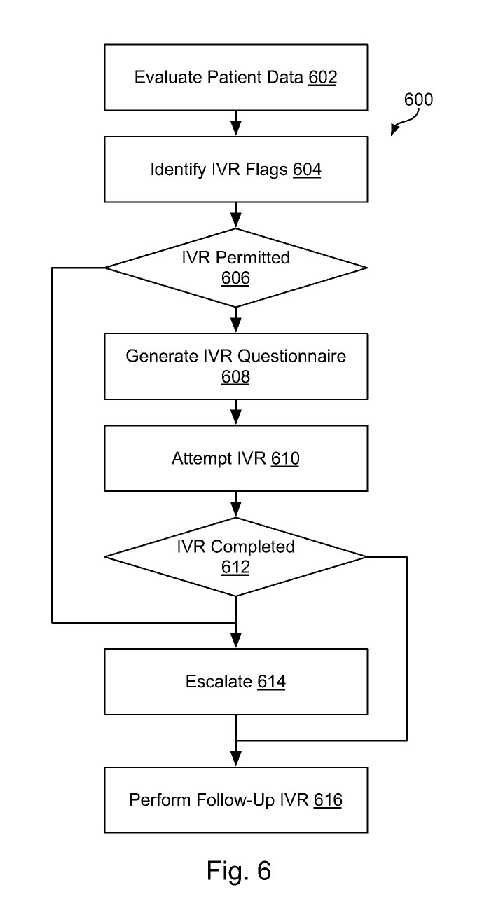

Referring to FIG. 6, in some embodiments, the illustrated method 600 may be used to perform an IVR call for a patient. The method 600 may be performed subsequent to detecting discharge of a patient and obtaining discharge orders for a patient according to methods disclosed herein. The method 600 may be executed by an executing system as for other methods disclosed herein either alone or in combination with a system of another entity operable to perform IVR phone calls.

The method 600 may include evaluating 602 patient data and identifying 604 any IVR flags 604. For example, the patient data evaluated may include discharge orders themselves, a patient profile available to the executing system, and other data relating to a patient and the patient's condition. For example, some conditions may indicate that a patient is not able to participate in an IVR call in a meaningful way, such as due to dementia, diminished capacity, deafness, or some other condition. Accordingly, identifying IVR flags 604 may include evaluating any express flags or other data in the patient data that indicates ineligibility for participating in an IVR call. In some embodiments, a patient may be flagged as ineligible based on responses to an IVR call, e.g. erratic or incoherent responses, and this flag stored for later use according to the method 600.

If an IVR call is found 606 to be appropriate in view of the identified 604 flags, then an IVR questionnaire may be generated 608 and an IVR attempted 610 in the same manner as for the method 500. Likewise, as for the method 500, if an IVR is not found 612 to have been completed, e.g. completed within a desired time interval, then the method 600 may include performing 614 one or more escalation actions in the same manner as for the method 500. In instances where a IVR is not found 606 to be permitted, the method 600 may include performing 614 the escalation actions without first attempting an IVR. For example, for someone ineligible for an IVR call, the method 600 may include generating a prompt to perform an in-person visit or a phone call to the patient, a responsible party, e.g. family member, guardian, in-home care provider, or other individual.

The method 600 may further include performing 616 a follow-up IVR call in the same manner as for the method 500. In instances where an IVR call is not found 606 to be permitted, step 616 may include asking the same or similar questions or otherwise obtaining the same information in some other fashion, such as an in-person visit or phone call, or some other escalation action, as noted for step 614. In some embodiments, based on responses to the IVR questionnaire, an escalation action may be performed if the patient responses indicate that action is needed. For example, escalation may include any escalation described herein, e.g. alerting a PCP, nurse, in-home care provider, concerned individual, or some other entity.

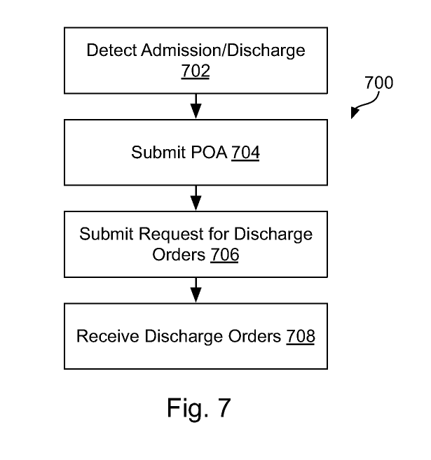

Referring to FIG. 7, as noted above, an entity performing the methods disclosed herein may be a different entity than a hospital or other facility that discharges a patient. Accordingly, the method 700 may be executed in order to obtain discharge orders for use in accordance with the methods disclosed herein. The method 700 may be executed by an executing system as for the other methods disclosed herein.

The method 700 may include detecting 702 one or both of admission and discharge of the patient in the same manner as for any of the methods described herein. The executing system may then submit 704 a power of attorney for the patient to the discharging entity in response to the detecting step 702. The power of attorney may be in digital form, such as a scanned image of a signed power of attorney or other document authorizing the entity associated with the executing system to access medical records of the patient. Accordingly, submitting 704 may be performed automatically by the computer system by means of email, fax, or some other communication modality.

The method 700 may further include submitting 706 a request for discharge orders. Submitting 706 the request for discharge may be performed in the same manner as the submission 704 of the power of attorney and may be performed simultaneously, e.g. as part of the same fax, email, or other communication. The discharge orders may then be received 708 from the discharging entity. The orders may be received by means of a fax or email and may be stored and analyzed in electronic form (optical character recognition) to obtain the data included therein. In some embodiments, the orders may be received 708 in paper form and scanned and analyzed to obtain the included information.

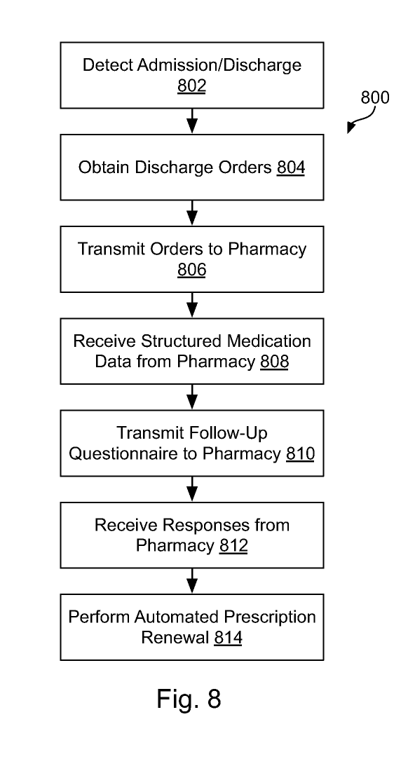

Referring to FIG. 8, in some embodiments a pharmacy or entity hosting a pharmacy may participate in ensuring that a patient receives post-discharge interactions to reduce risk of readmission. The method 800 may be executed by an executing system communicating with a computer system associated with a pharmacy (“pharmacy system”). The method 800 may include detecting 802 one or both of admission and discharge and obtaining discharge orders 804 as for other methods described herein.

The method 800 may further include transmitting 806 at least a portion of the discharge orders 804 to the pharmacy system. For example, a portion of the discharge orders may include medications and instructions for medications to be administered to the patient. Accordingly, at least this section may be transmitted 806 to the pharmacy system. The pharmacy system may then extract the medications, amounts, dosage schedule, refill schedule, and the like form the orders and return them to the executing system. The executing system may receive 808 the extracted information as structured data that may be used in a computing system to schedule tasks, such as any of the systems for scheduling and updating tasks disclosed in the applications incorporated herein by reference in the “Related Applications” section.

The method 800 may further include transmitting 810 to the pharmacy system a questionnaire of follow up questions for the patient. The questionnaire may be generated as described above with respect to the methods 500 and 600. The pharmacy may receive the questionnaire and prompt a pharmacist to discuss the questionnaire with the patient. For example, the pharmacy system may be configured to issue a prompt upon detecting filling of a prescription of the patient, the prompt indicating that the patient should participate in a questionnaire. The prompt may include an interface enabling a pharmacist to invoke display of the questionnaire and an interface for inputting patient responses to the questionnaire. The responses to the questions may be received and then transmitted to the executing system. The executing system 812 may then receive the responses and store them for later use. For example, the response may be used to determine a subsequent questionnaire for a subsequent IVR call or for evaluating by a pharmacist with a patient in the same manner as for an original questionnaire. The method 800 may further use the structured data received 808 to generate tasks corresponding to dosages and perform 814 automated prescription renewal, e.g. transmit electronic requests for prescription fulfillment to a pharmacy when appropriate according to a dosage schedule and a prescription.

In some embodiments, medications extracted by the pharmacy or otherwise communicated by the pharmacy, may be use by the pharmacy system to generate a refill schedule accessible by the pharmacy system. The pharmacy system may additionally or alternatively be granted access to medication information of an executing system (e.g. health care agency) and use this information to have prescriptions ready at appropriate times, appropriate stocks of drugs to fill prescriptions by the date needed, and the like.

In some embodiments, a trained pharmacist may modify dosages of one or more medications of the patient and update a dosage instructions in a database of the pharmacy system and/or transmit such updates to an executing system for updating an agency database.

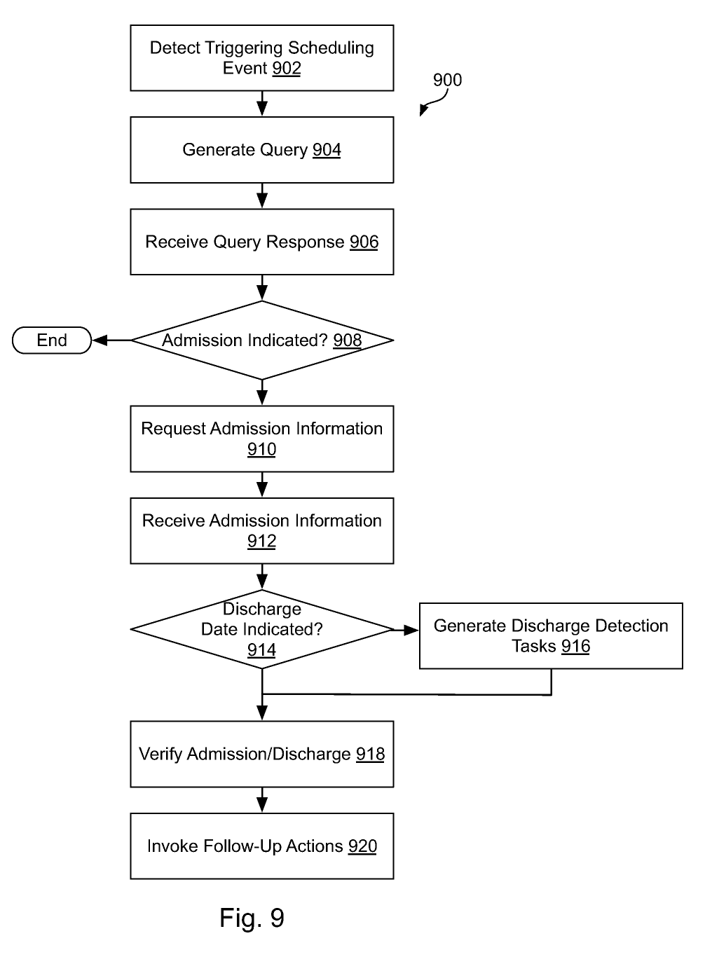

As noted above, in order to facilitate activities to reduce risk of readmission, a health care agency or other constituency may advantageously use the methods disclosed herein to provide reliable ways of capturing the incidence of hospital admissions and/or discharge. As described in greater detail with respect to FIGS. 9 through 12, a scheduling system, such as that disclosed in the applications incorporated by reference in the “Related Applications” section, may be used to increase the probability of capturing every hospital admission for each recipient. In particular, the methods of FIGS. 9 through 12 advantageously use care managers and the day-to-day caregivers interfacing with the scheduling system and use proactive prompts to detect admission and/or discharge rather than depending exclusively on the compliance of the care managers to enter information. In some embodiments, a scheduling system may be configurable to omit proactive tracking of admissions, such as by means of a “Track Admissions” environment variable or setting.

For example, as discussed in greater detail with respect to FIG. 9, a care manager may be prompted to provide a reason (e.g. a hospital admission) whenever the care manager takes an action that could be a result of an admission such as deactivating a client, deleting a schedule, or adding a new client in the scheduling system.

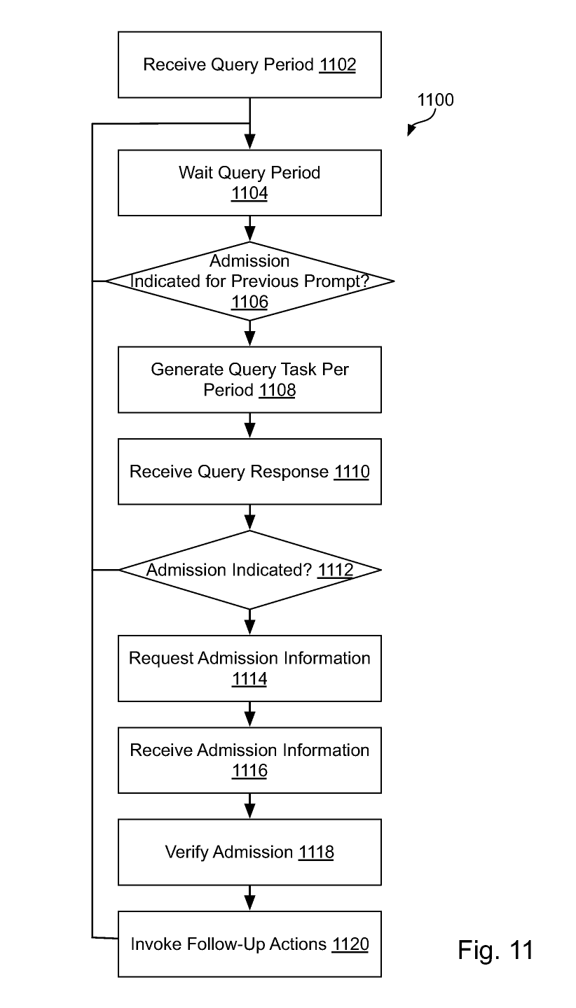

As discussed in greater detail with respect to FIG. 11, caregivers may be periodically asked whether or not there was a hospital admission for a given recipient. The period of the repeated asks can be configurable by an agency. For instance, the caregiver could be prompted to respond as to whether there was a hospital admission since a last visit, last prompt, or other event, upon telephony clock out of every visit as discussed in the applications of the “Related Applications,” but no more than once per week, or some other minimum period. In the event that there is a reported hospital admission, then the caregiver may be prompted to provide additional details that are then entered to the client's record and submitted to the care manager for verification. In this event, a task is automatically created for the care manager to verify the details of the hospital admission.

Referring specifically to FIG. 9, a method 900 may be performed by an executing computer system on behalf of a recipient. The method 900 may include detecting 902 a triggering scheduling event among actions performed on a scheduling database, such as by means of a scheduling system disclosed in the applications of the “Related Applications” section. A triggering scheduling event may be one that could follow and/or precede admission and/or discharge of a recipient from an inpatient facility, such as a hospital, rehab facility, or other facility. For example, a triggering scheduling event may include adding of a new recipient to a scheduling database, adding of a new potential recipient (e.g. prospect) to the scheduling database, re-activation of a recipient (e.g. a change in status of the recipient such that care activities will now be scheduled and reported for the recipient on a regular basis using the scheduling system), any status update or comment in a scheduling system marked with a tag indicating admission to an inpatient facility, deactivation of a recipient from further scheduling of care, deletion of a scheduled shift or task for a recipient, and deletion of a scheduled shift or task for a recipient with a reason therefore being admission to an inpatient facility.

In response to detecting 902 the triggering scheduling event, the method 900 may include generating 904 a query and receiving 906 a response to the query. A query may be generated 904 by means of any communication modality and the response may be received 906 by the same or a different modality. For example, the query may be made by means of an automated telephone call, email, a user interface element (pop up window, textual message, or the like) in an interface to a scheduling system, text message, or other communication modality. A care manager or other entity receiving the query may then respond by the same or a different communication modality.

The method 900 may include evaluating 908 whether the received 906 response indicates that an admission has occurred for the recipient. If not, then the method 900 may end. If so, then the method 900 may include requesting 910 admission information and receiving 912 admission information. The requesting 910 and receiving 912 may be by means of any communication modality, such as an interface to a scheduling system, interactive voice telephony, or some other communication modality.

Requesting 910 admission information may include requesting an indication of the condition for which the recipient was admitted. The request may be accompanied by a list (e.g. drop down menu) listing possible conditions, conditions for which the recipient has been treated previously, or some other set of conditions that are either generally applicable or selected as being relevant to the recipient.

Requesting 910 admission information may include requesting a discharge date for the admission. A response to the request 910 may indicate an actual date of discharge, expected date of discharge, or indicate that the date of discharge is unknown. Accordingly, the method 900 may include evaluating 914 whether the response indicated a discharge date. If not, the method 900 may include generating one or more tasks to determine the discharge date. For example, a task having an expected completion date, independently updateable status, or other information may be generated 916 and reminders generated and updates to the status thereof received according to the scheduling system, such as the scheduling system disclosed in the applications of the “Related Applications” section. As a result of the generated 916 task, the discharge date may be received, such as by means of the scheduling system using any communication modality.

The method 900 may further include additional steps such as verifying 918 one or both of the admission and discharge and invoking 920 one or more follow up activities to reduce the risk of readmission as described hereinabove. In some embodiments, the method 900 may further include performing again some or all of steps 904-918 with respect to any admission and discharge to a rehabilitation facility following an admission found to have occurred at step 908.

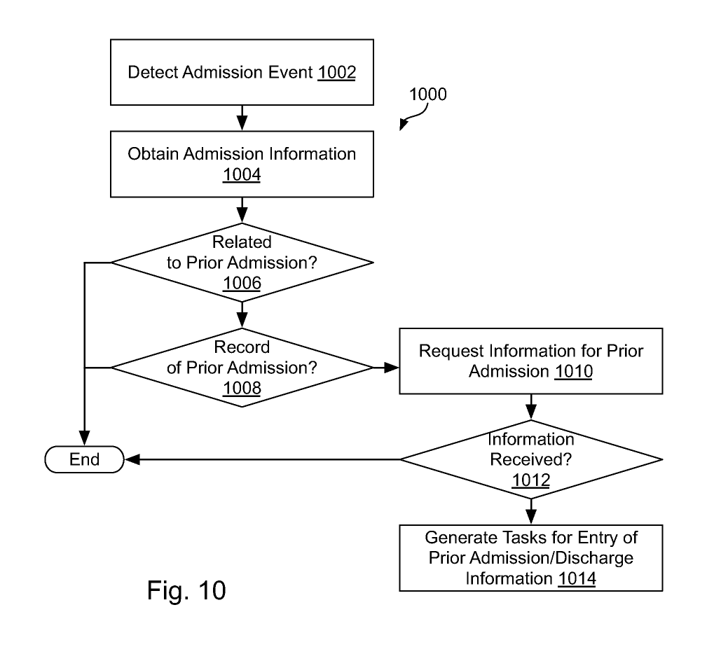

FIG. 10 illustrates a method 1000 that may be performed by an executing computer system on behalf of the recipient, such as the recipient in the method 900 for which an admission has been detected. The illustrated method 1000 may be advantageously executed where the scheduling triggering event detected 902 in the method 900 is one or more of detecting an activity for the recipient in a scheduling system marked with a tag indicating admission to an inpatient facility, deactivation of a recipient with the reason noted therefor being noted as admission to an inpatient facility, deletion of a portion of scheduled shifts and/or tasks for the recipient with the reason therefore being noted as admission to an inpatient facility.

As shown in FIG. 10, the method 1000 may include detecting 1002 an admission event, such as according to the method 900 or some other means for detecting admission and/or discharge disclosed hereinabove. The method 1000 may further include obtaining 1004 information for the detected 1002 admission as for the method 900.

The method 1000 may further include evaluating 1006 whether the detected 1002 admission was related to a prior admission. Step 1006 may include presenting in an interface to a scheduling system a prompt requesting a user to indicate whether the admission is related to a prior admission within the last N days (e.g. 30 days) along with a list (e.g. drop down menu) that lists the dates of some or all previous admissions indicated in records accessible to the scheduling system if any, e.g. admissions accessible by the scheduling system and dated within the last N days.

If no prior related admission is found at step 1006, the method 1000 may end. If an admission is found to have occurred, the method 1000 may include evaluating whether the related prior admission is already represented in records accessible by the scheduling system. If so, then the method 1000 may end. If not, then the method 1000 may include requesting 1010 information for the prior admission, e.g. some or all of the information requested with respect to the method 900. If the information requested is received 1012, the method 1000 may end. If a response to the request is “I don't know” or some other response that indicates that the information is unknown, a task may be generated 1014 to remind a care manager to obtain the information. The task may be generated, used to generate reminders, and the completion status thereof updated according to the methods of the applications of the “Related Applications” section.

Referring to FIG. 11, a method 1100 may be executed by an executing system on behalf of a recipient with respect to one or more providers scheduled to provide care by a scheduling system and reporting completion of care tasks to the scheduling system, such as according to methods disclosed in the applications of the “Related Applications” section.

The method 1100 may include receiving 1102 a query period, e.g. a period of N days, weeks, or other unit of time. The query period may be received for a particular patient, received as a general setting for all recipients scheduled by the scheduling system, or be specified as a default value in software implementing the method 1100.

The method 1100 may further include waiting 1104 for the query period to pass, evaluating 1106 whether an admission was reported in response to a previous prompt. If no admission is found 1106 to be reported, the method may include generating 1108 a task to respond to a query regarding admissions. The tasks may be generated, stored, presented to a provider, and updated according to methods described in the applications of the “Related Applications” section. For example, a caregiver may be provided a prompt as part of a lists of tasks read to the caregiver or as part of a clock-out or clock-in routine using a computer interface or voice telephony routine as described in the applications of the “Related Applications” section. The task may include a query asking whether an admission has occurred (e.g. press 1 if admission has occurred) and if so, generating a prompt asking for, and receiving, a date of admission, date of discharge, and/or other information relating to the admission.

A response may be received 1110 in response to the generated 1108 query. The response may be received by any modality, such as over a voice telephony network, interface to a scheduling system, or the like.

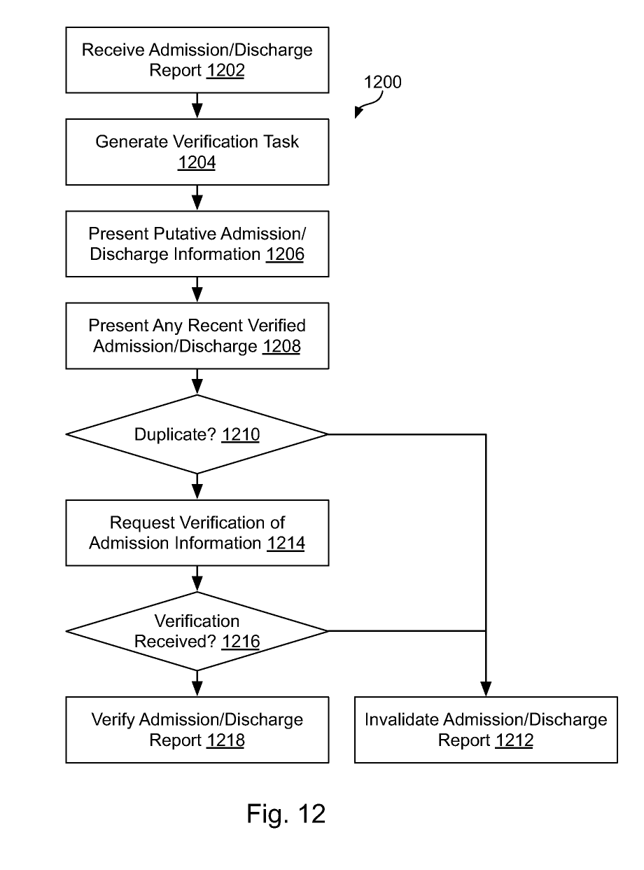

The response may be evaluated 1112. If the response does not indicate that admission occurred, the method 1100 may continue to generate period queries according to the query, such as by repeating some or all of steps 1104-1112. If the response is found 1112 to indicate that admission occurred, then the method 1100 may include requesting 1114 admission information, receiving 1116 admission information, and verifying 1118 the admission information. Requesting and receiving 1114, 1116 admission information may be performed according to one or both of the method 900 and the method 1100. For example, a caregiver indicating that admission has occurred in response to the query at step 1108 may be a triggering scheduling event (step 902) and/or admission event (step 1002). Verifying 1118 the admission may be performed according to the method 1200 of FIG. 12, below. If the admission is verified, the method 1100 may include invoking 1120 one or more follow-up actions to reduce risk of readmission as described hereinabove.

The method 1200 of FIG. 12 may be executed by an executing system on behalf of the recipient. In some embodiments, a care agency may designate one individual to invoke and/or participate in execution of the method 1200, e.g. an “admissions manager.” The method 1200 may include receiving 1202 a report of an admission and/or discharge, such as a report of an admission and/or discharge provided by a caregiver according to the method 1100. The method may further include generating 1204 a verification task. The verification task may be a task defined and processed according to the methods disclosed in the applications of the “Related Applications” section. For example, periodic reminders by email or some other communication modality may remind a care manager to verify the reported admission. The verification task may, for example, include an interface element labeled “Verify Details” that, when selected, generates a prompt of the form “Verify details of hospital discharge for [recipient identifier] reported on [date] by [caregiver identifier]. Hospital discharged reported as [date].” The verification task may further include executing one or both of method 900 and 1000 with respect to the recipient and the reported admission.

The method 1200 may further include updating the status of the verification task by presenting 1206 putative admission and/or discharge information as reported by a caregiver and presenting 1208 any recent, verified admissions and/or discharges. The method 1200 may include prompting the care manager to indicate whether the putative admission and/or discharge is a duplicate of a verified admission and/or discharge and receiving a response to the prompt. If the prompt is found 1210 to indicate a duplicate, then the reported admission and/or discharge may be invalidated 1212. A record of the invalid report may be stored along with an indication that it is invalid.

If the putative admission and/or discharge is not found 1210 to be a duplicate, the method 1200 may include requesting 1214 verification of the admission information. This may include presenting some or all information relating to a reported admission and/or discharge (e.g. admission date, discharge date, reason for admission, facility of admission, whether admitted to rehab, whether discharged from rehab, and the like). A prompt may be generated requesting that the care manager indicate whether the information is accurate and a response to the prompt may be received. An activity record may be stored by the scheduling system with such information as the caregiver that reported the admission, the date of the report, the care manager that marked the report as false, and a date that the report was marked as false by the care manager.

If the response if found 1216 to indicate that the putative admission and/or discharge is invalid, then step 1212 may be executed. In some embodiments, if a report is to be invalidated, a care manager may be prompted to confirm that the report is in fact invalid and a response to the prompt may be received. If the response confirms that the report is invalid, then a record of the invalid report may be generated as described above with respect to step 1212.

Otherwise, the method 1200 may include verifying 1218 the admission and/or discharge such as by storing a record of the admission and/or discharge in a database and/or marking a record of the admission and/or discharge as valid.

In some embodiments, if the admission is verified, a record of the admission and/or discharge may be recorded as an activity in the scheduling system in association with the patient that was admitted. The record may include any details of the admission, such as date, discharge date, reason for admission, facility in which admitted, and the like.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The software code may also include scripting languages such Pearl, Python, PHP, and the like. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention, this is used for transitive and non-transitive storage. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state during transitive and non-transitive storage. The invention is not limited to any particular type of memory device, or any commonly used protocol for storing and retrieving information to and from these memory devices, respectively.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

1. A method for improving healthcare outcomes, the method comprising:
detecting by a first computer system of a first entity, discharge of a patient from a second entity based on activities of the patient;
transmitting, by the first computer system to an electronic device associated with the second entity, a request for the discharge information of the patient;
automatically scheduling one or more follow-up activities for the patient; and
verifying participation of the patient in the one or more follow-up activities.

2. The method of claim 1, wherein the one or more follow-up activities is a visit to a health care professional.

3. The method of claim 2, wherein automatically scheduling the one or more follow-up activities includes notifying the health care professional of a need to schedule an appointment.

4. The method of claim 3, wherein automatically scheduling the one or more follow-up activities includes scheduling transportation to the health care professional.

5. The method of claim 4, wherein scheduling transportation includes scheduling coordinated transportation for the patient and one or more other patients associated with the second entity.

6. The method of claim 3, wherein verifying participation of the patient in the one or more follow-up activities includes verifying participation of the patient in the visit to the health care professional.

7. The method of claim 1, wherein detecting discharge comprises detecting presence of the patient at the first entity for an above-threshold period of time.

8. The method of claim 7, wherein detecting presence of the patient at the first entity includes geotracking the patient.

9. The method of claim 7, wherein detecting presence of the patient at the first entity includes detecting a radio frequency identification (RFID) device worn by the patient.

10. The method of claim 1, wherein detecting discharge of the patient includes:
generating, by the first computer system, a prompt to an entity other than the second entity, the prompt including a request to indicate that the patient has been discharged; and
receiving, by the first computer system, response indicating that the patient has been discharged.

11. The method of claim 1, wherein automatically scheduling the one or more follow-up activities includes scheduling an interactive voice response (IVR) dialog with the patient, the method further comprising attempting performing the IVR dialog with the patient.

12. The method of claim 11, further comprising generating content of the IVR dialog according to the discharge information.

13. The method of claim 12, further comprising generating a follow-up dialog based on responses of the patient to the IVR dialog.

14. The method of claim 1, wherein automatically scheduling the one or more follow-up activities includes:
evaluating a profile of the patient;
determining that the patient is not eligible for an interactive voice response dialog;
generating a prompt to perform an in-person interaction with the patient.

15. The method of claim 14, wherein evaluating the profile of the patient includes evaluating whether the profile includes a flag indicating dementia.

16. The method of claim 1, wherein automatically scheduling the one or more follow-up activities for the patient includes scheduling a personal phone call to the patient, the method further comprising:
automatically generating questions for use in the personal phone call based on the discharge information; and
generating a prompt to perform the personal phone call.

17. The method of claim 16, further comprising:
detecting failure of the patient to participate in the personal phone call; and
in response to detecting failure of the patient to participate in the personal phone call, generating a prompt to make a personal visit to the patient.

18. The method of claim 1, further comprising:
transmitting at least a portion of the discharge information to a third computer system associated with a pharmacy entity;
receiving from the third computer system a structured representations of medications and dosages from the discharge information;
scheduling tasks in a scheduling system of the first entity corresponding to at least one of dosages and refills according to the representations of the medications and dosages.

19. The method of claim 18, wherein automatically scheduling the one or more follow-up activities for the patient includes:
transmitting a questionnaire to the third computer system for completion upon filling of a prescription included in the discharge information; and
receiving, from the third computer system, responses to the questionnaire.

20. The method of claim 1, wherein requesting, by the first computer system from the second computer system of the second entity, discharge information for the patient further includes:
submitting an electronic power of attorney to the first computer system by the second computer system.

21. The method of claim 1, further comprising:
generating one or more tasks to an in-home care scheduling system for the second entity, each of the one or more tasks having an independently updatable status associated therewith.

22. A method for improving healthcare outcomes, the method comprising:
detecting by a first computer system of a first entity, a scheduling discontinuity in scheduling of periodic activities for a recipient;
in response to detecting the scheduling discontinuity, by the first computer system, generating a prompt to indicate whether at least one of an admission and a discharge of the recipient to an inpatient facility has occurred;
receiving, by the first computer system, a response to the prompt;
determining, by the first computer system, that the prompt indicates that at least one of an admission and a discharge from an inpatient facility has occurred; and
in response to determining that the prompt indicates that at least one of the admission and the discharge from the inpatient facility has occurred, automatically generating, by the first computer system, one or more follow-up tasks in a scheduling database storing scheduling data for the periodic activities.

23. The method of claim 22, wherein the one or more follow-up tasks include a task to determine a discharge date associated with the at least one of the admission and the discharge.

24. The method of claim 22, wherein the one or more follow-up tasks include a task to obtain from a second entity discharge information associated with the at least one of the admission and the discharge.

25. The method of claim 22, wherein the one or more follow-up tasks include a tasks to verify occurrence of the at least one of the admission and the discharge.

26. The method of claim 22, further comprising, in response to determining that the prompt indicates that at least one of the admission and the discharge from the inpatient facility has occurred:
transmitting, by the first computer system to an electronic device associated with the second entity, a request for the discharge information of the patient;
automatically scheduling one or more follow-up activities for the patient; and
verifying participation of the patient in the one or more follow-up activities.

27. A method for improving healthcare outcomes, the method comprising:
receiving, by a computer system associated with a first entity, specification of a plurality of tasks to be performed for a recipient by one or more providers;
automatically generating, by the computer system, periodic admission tasks, the admission tasks including an instruction to specify whether the recipient has been admitted for inpatient care associated with a second entity different from the first entity;
presenting, by the computer system, the plurality of tasks and the periodic admission tasks to the recipient;
receiving, by the computer systems updates to statuses of the plurality of tasks and the periodic admission tasks;
determining, by the computer system, that the update for at least one of the periodic admission tasks indicates admission to an inpatient facility;
in response to determining that the update for the at least one of the periodic admission tasks indicates admission to the inpatient facility, automatically generating, by the first computer system, one or more follow-up tasks in a scheduling database storing scheduling data.

28. The method of claim 27, wherein presenting, by the computer system, the plurality of tasks and the periodic admission tasks to the recipient further comprises invoking, by the computer system, reading over a voice telephony network descriptions of a portion of the plurality of tasks associated with a shift of a provider of the one or more providers and a periodic admission task of the periodic admission tasks; and
wherein receiving, by the computer systems updates to the statuses of the plurality of tasks and the periodic admission tasks further comprises receiving over the voice telephony network updates to the statuses of the portion of the plurality of tasks and the periodic admission task of the periodic admission tasks.

28. The method of claim 27, wherein the one or more follow-up tasks include a task instructing a care manager to verify the admission.

29. The method of claim 27, wherein the one or more follow-up tasks include a task instructing a care manager to determine a date of discharge from the inpatient facility.

30. The method of claim 27, wherein the one or more follow-up tasks include one or more follow-up interactions with a health care professional following discharge from the inpatient facility, the method further comprising:
verifying participation of the recipient in the one or more follow-up interactions.
